(19) United States
(12) Patent Application Publication
(10) Pub. No.: US 2019/0021007 A1
(43) Pub. Date: Jan. 17, 2019

(54) STATION-AIDED SPATIAL REUSE GROUP DETECTION

(71) Applicant: QUALCOMM Incorporated, San Diego, CA (US)

(72) Inventors: Yan Zhou, San Diego, CA (US); George Cherian, San Diego, CA (US)

(21) Appl. No.: 15/648,302

(22) Filed: Jul. 12, 2017

(51) Int. Cl. H04W 16/02; H04W 72/04

(52) U.S. Cl. CPC H04W 16/02; H04W 84/12; H04W 72/0413; H04W 72/042

(57) ABSTRACT

Methods, systems, and devices for wireless communication are described. A first access point associated with a first basic service set may transmit spatial reuse group (SRG) parameters for neighboring SRGs. The stations in the first basic service set may report information about neighboring SRG access points to the first access point. A station may determine whether a transmission is associated with a SRG access point and report color and/or identifier information for the access point to the first access point. The first access point may update the information about neighboring SRGs based at least in part on the information reported by the stations.

### BACKGROUND

The following relates generally to wireless communication, and more specifically to station-aided spatial reuse group detection.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

In a WLAN, an AP together with its associated STAs are called a basic service set (BSS). In some cases, a first BSS may spatially overlap with one or more other BSSs. For example, at least some members of a second BSS and a third BSS may be within the transmission range of the AP in the first BSS. In such cases, each BSS may be identified by an identification number (e.g., a BSS identification (BSSID)). Each BSS may also be identified by a color code. Each frame transmitted within a BSS may include at least one of the identification number and the color code to allow the members of the BSS to identify the frame as being transmitted within the BSS. In some examples, a STA in the first BSS may detect a WLAN frame and determine, based on the identification number and/or the color code in the WLAN frame, whether the WLAN frame is associated with the first BSS or another BSS (e.g., the second BSS or the third BSS). The STA may set decisions on medium contention and interference management accordingly.

### SUMMARY

The described techniques relate to improved methods, systems, devices, or apparatuses that support station-aided spatial reuse group detection.

A method of wireless communication is described. The method may include receiving, by a station (STA) associated with a first access point (AP), a transmission from a second AP, determining that the second AP is a member of a spatial reuse group based at least in part on receiving the transmission, and transmitting, to the first AP, one or more parameters of the second AP, the one or more parameters comprising at least one of a color parameter for the second AP or an identifier for the second AP.

An apparatus for wireless communication is described. The apparatus may include means for receiving, by a station (STA) associated with a first access point (AP), a transmission from a second AP, means for determining that the second AP is a member of a spatial reuse group based at least in part on receiving the transmission, and means for transmitting, to the first AP, one or more parameters of the second AP, the one or more parameters comprising at least one of a color parameter for the second AP or an identifier for the second AP.

Another apparatus for wireless communication is described. The apparatus may include a processor, memory in electronic communication with the processor, and instructions stored in the memory. The instructions may be operable to cause the processor to receive, by a station (STA) associated with a first access point (AP), a transmission from a second AP, determine that the second AP is a member of a spatial reuse group based at least in part on receiving the transmission, and transmit, to the first AP, one or more parameters of the second AP, the one or more parameters comprising at least one of a color parameter for the second AP or an identifier for the second AP.

A non-transitory computer readable medium for wireless communication is described. The non-transitory computer-readable medium may include instructions operable to cause a processor to receive, by a station (STA) associated with a first access point (AP), a transmission from a second AP, determine that the second AP is a member of a spatial reuse group based at least in part on receiving the transmission, and transmit, to the first AP, one or more parameters of the second AP, the one or more parameters comprising at least one of a color parameter for the second AP or an identifier for the second AP.

Some examples of the method, apparatus, and non-transitory computer-readable medium described above may further include processes, features, means, or instructions for receiving, from the first AP, information indicative of one or more parameters of spatial reuse groups within a coverage area of the first AP.

Some examples of the method, apparatus, and non-transitory computer-readable medium described above may further include processes, features, means, or instructions for determining, based at least in part on the transmission, that the at least one of the color parameter or the identifier for the second AP may be unknown to the first AP. Some examples of the method, apparatus, and non-transitory computer-readable medium described above may further include processes, features, means, or instructions for transmitting the one or more parameters of the second AP to the first AP based at least in part on the determining that the at least one of the color parameter or the identifier may be unknown to the first AP.

Some examples of the method, apparatus, and non-transitory computer-readable medium described above may further include processes, features, means, or instructions for receiving, from the first AP, a request to report one or more parameters of spatial reuse groups within a coverage area of the STA. Some examples of the method, apparatus, and non-transitory computer-readable medium described above may further include processes, features, means, or instructions for transmitting the one or more parameters of the second AP to the first AP based at least in part on the request.

Some examples of the method, apparatus, and non-transitory computer-readable medium described above may further include processes, features, means, or instructions for determining that the second AP may be a member of a spatial reuse group based at least in part on a spatial reuse group info presence flag in the transmission.

Some examples of the method, apparatus, and non-transitory computer-readable medium described above may further include processes, features, means, or instructions for determining that the second AP may be a member of a spatial reuse group based at least in part on a spatial reuse signal strength maximum or a spatial reuse signal strength minimum identified in the transmission.

Some examples of the method, apparatus, and non-transitory computer-readable medium described above may further include processes, features, means, or instructions for receiving, from the first AP, a spatial reuse definition. Some examples of the method, apparatus, and non-transitory computer-readable medium described above may further include processes, features, means, or instructions for determining that the second AP may be a member of a spatial reuse group based at least in part on the spatial reuse definition.

In some examples of the method, apparatus, and non-transitory computer-readable medium described above, the identifier for the second AP comprises a partial identifier for the second AP.

In some examples of the method, apparatus, and non-transitory computer-readable medium described above, the one or more parameters of the second AP comprises at least one of a color bitmap identifying the color parameter of the second AP or a partial BSSID identifier bitmap identifying the partial BSSID of the second AP.

In some examples of the method, apparatus, and non-transitory computer-readable medium described above, the one or more parameters of the second AP comprises at least one of a color index corresponding to the color parameter of the second AP and a group identifier index of the second AP.

In some examples of the method, apparatus, and non-transitory computer-readable medium described above, the identifier for the second AP comprises a full BSSID of the second AP.

In some examples of the method, apparatus, and non-transitory computer-readable medium described above, the one or more parameters of the second AP comprises at least one of a signal strength minimum offset for the second AP, a signal strength maximum offset for the second AP, and spatial reuse control information for the second AP.

Some examples of the method, apparatus, and non-transitory computer-readable medium described above may further include processes, features, means, or instructions for receiving, from the first AP, a spatial reuse report request, the spatial reuse report request comprising at least one of a request identifier, a report response time, a spatial reuse definition, and a report configuration. Some examples of the method, apparatus, and non-transitory computer-readable medium described above may further include processes, features, means, or instructions for transmitting the one or more parameters of the spatial reuse group based at least in part on the reuse report request.

Some examples of the method, apparatus, and non-transitory computer-readable medium described above may further include processes, features, means, or instructions for receiving a second transmission from a third AP. Some examples of the method, apparatus, and non-transitory computer-readable medium described above may further include processes, features, means, or instructions for determining that the third AP may be not a member of any spatial reuse group based at least in part on receiving the second transmission. Some examples of the method, apparatus, and non-transitory computer-readable medium described above may further include processes, features, means, or instructions for determining not to report spatial reuse parameters of the third AP based at least in part on determining that the third AP may be not a member of any spatial reuse group.

Some examples of the method, apparatus, and non-transitory computer-readable medium described above may further include processes, features, means, or instructions for receiving updated information indicative of one or more parameters of spatial reuse groups within a coverage area of the first AP, the updated information indicative of the one or more parameters of the spatial reuse groups comprising the one or more parameters for the spatial reuse group.

Some examples of the method, apparatus, and non-transitory computer-readable medium described above may further include processes, features, means, or instructions for transmitting the one or more parameters of the spatial reuse group to the first AP comprises periodically transmitting the one or more parameters of the spatial reuse group to the first AP.

A method of wireless communication is described. The method may include transmitting, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP, receiving, from a STA of the plurality of STAs in the BSS, second spatial reuse information that comprises at least one of a color or an identifier of a third AP in the spatial reuse group, and generating third spatial reuse information based at least in part on the second spatial reuse information received from the STA.

An apparatus for wireless communication is described. The apparatus may include means for transmitting, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP, means for receiving, from a STA of the plurality of STAs in the BSS, second spatial reuse information that comprises at least one of a color or an identifier of a third AP in the spatial reuse group, and means for generating third spatial reuse information based at least in part on the second spatial reuse information received from the STA.

Another apparatus for wireless communication is described. The apparatus may include a processor, memory in electronic communication with the processor, and instructions stored in the memory. The instructions may be operable to cause the processor to transmit, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP, receive, from a STA of the plurality of STAs in the BSS, second spatial reuse information that comprises at least one of a color or an identifier of a third AP in the spatial reuse group, and generate third spatial reuse information based at least in part on the second spatial reuse information received from the STA.

A non-transitory computer readable medium for wireless communication is described. The non-transitory computer-readable medium may include instructions operable to cause a processor to transmit, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP, receive, from a STA of the plurality of STAs in the BSS, second spatial reuse information that comprises at least one of a color or an identifier of a third AP in the spatial reuse group, and generate third spatial reuse information based at least in part on the second spatial reuse information received from the STA.

Some examples of the method, apparatus, and non-transitory computer-readable medium described above may further include processes, features, means, or instructions for transmitting a request to report spatial reuse information to the plurality of STAs in the BSS. Some examples of the method, apparatus, and non-transitory computer-readable medium described above may further include processes, features, means, or instructions for receiving the second spatial reuse information based at least in part on the request to report spatial reuse information.

Some examples of the method, apparatus, and non-transitory computer-readable medium described above may further include processes, features, means, or instructions for transmitting a spatial reuse definition to the plurality of STAs in the BSS.

In some examples of the method, apparatus, and non-transitory computer-readable medium described above, the second spatial reuse information comprises at least one of a color bitmap identifying a color parameter for the second AP and an identifier for the second AP.

In some examples of the method, apparatus, and non-transitory computer-readable medium described above, the second spatial reuse information comprises at least one of a color index corresponding to the color parameter for the second AP and a identifier index corresponding to the identifier for the second AP.

Some examples of the method, apparatus, and non-transitory computer-readable medium described above may further include processes, features, means, or instructions for transmitting a report request comprising a spatial reuse report time to the STA.

Some examples of the method, apparatus, and non-transitory computer-readable medium described above may further include processes, features, means, or instructions for creating the third spatial reuse information based at least in part on the second spatial reuse information and additional spatial reuse information provided by other STAs of the plurality of STAs in the BSS.

Some examples of the method, apparatus, and non-transitory computer-readable medium described above may further include processes, features, means, or instructions for creating the third spatial reuse information by updating the first spatial reuse information based at least in part on the second spatial reuse information.

### BRIEF DESCRIPTION OF THE DRAWINGS

FIG. 1 illustrates an example of a system for wireless communication that supports station-aided spatial reuse group detection in accordance with aspects of the present disclosure.

FIG. 2 illustrates an example of a wireless communications network that supports station-aided spatial reuse group detection in accordance with aspects of the present disclosure.

FIG. 3 illustrates an example of a flow diagram for communications in a wireless communications network that supports station-aided spatial reuse group detection in accordance with aspects of the present disclosure.

FIG. 4 illustrates an example of a flow diagram for communications in a wireless communications network that supports station-aided spatial reuse group detection in accordance with aspects of the present disclosure.

FIG. 5 illustrates an example of a spatial reuse element for use in communications in a wireless communications network that supports station-aided spatial reuse group detection in accordance with aspects of the present disclosure.

FIGS. 6 through 8 show block diagrams of a device that supports station-aided spatial reuse group detection in accordance with aspects of the present disclosure.

FIG. 9 illustrates a block diagram of a system including a STA that supports station-aided spatial reuse group detection in accordance with aspects of the present disclosure.

FIGS. 10 through 12 show block diagrams of a device that supports station-aided spatial reuse group detection in accordance with aspects of the present disclosure.

FIG. 13 illustrates a block diagram of a system including a AP that supports station-aided spatial reuse group detection in accordance with aspects of the present disclosure.

FIGS. 14 through 15 illustrate methods for station-aided spatial reuse group detection in accordance with aspects of the present disclosure.

### DETAILED DESCRIPTION

Stations (STAs) within a basic service set (BSS) may use group identifiers (e.g., basic service set identifiers (BSSIDs)) and color codes to determine whether a frame is transmitted within the BSS or by a device in another BSS. In order to be effective, the access point (AP) for the BSS may select a BSSID or a color code that is not selected by any other BSS in the area.

The AP may determine what other BSSs have devices in its coverage area by listening to the channel and extracting utilized BSSIDs and/or color codes from the received frames. However, the AP may not identify all BSSIDs and/or color codes used within the area of the BSS. For example, a device from another BSS may not be within the coverage area of the AP (such that the AP cannot hear transmissions from the device), but may be within the coverage area of a STA in the BSS (such that the STA can hear transmissions from the device).

In order to identify all BSSIDs and/or color codes in the area of the BSS, the STAs in the BSS may report information about the BSSIDs and/or color codes of received frames to the AP. The AP may transmit spatial reuse group (SRG) parameters for neighboring SRGs. The stations in the BSS may report information about neighboring SRG access points to the AP. A STA may determine whether a transmission is associated with a SRG access point and report color and/or identifier information for the SRG access point to the AP. The AP may update the information about neighboring SRGs based at least in part on the information reported by the STAs.

Aspects of the disclosure are initially described in the context of a wireless communications system. Aspects of the disclosure are further illustrated by and described with reference to apparatus diagrams, system diagrams, and flowcharts that relate to station-aided spatial reuse group detection

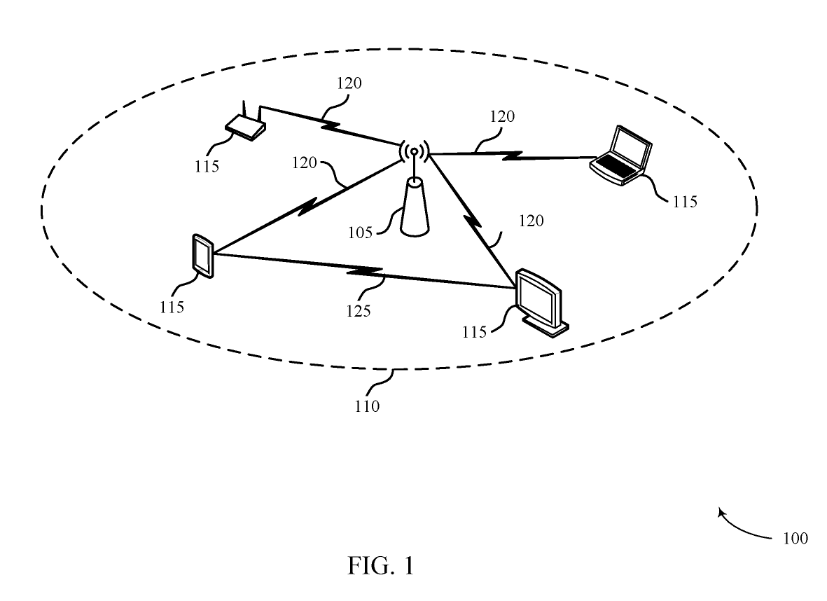

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS.

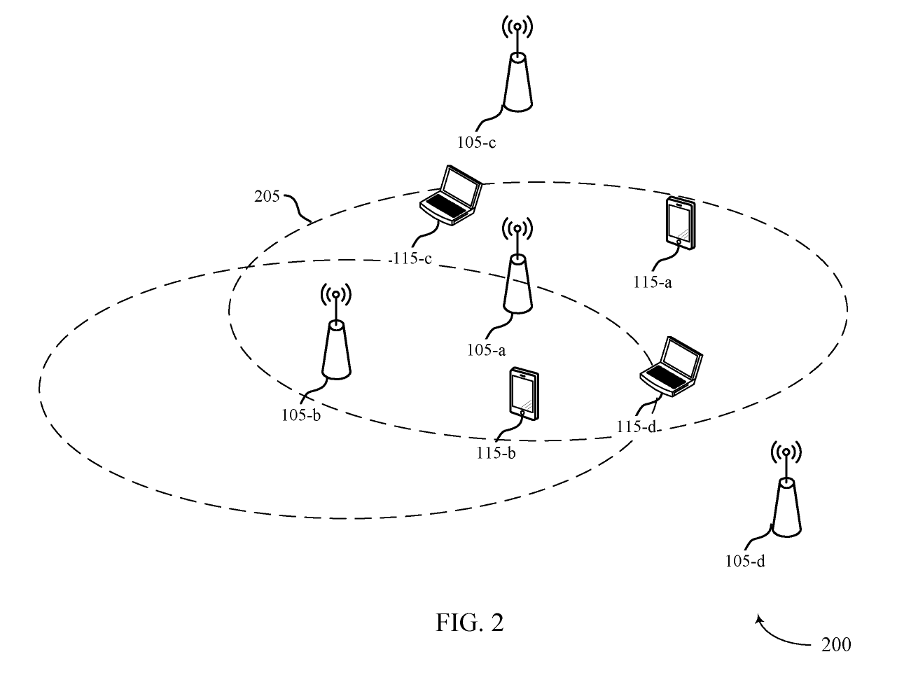

A STA 115 may be located in the intersection of more than one coverage area 110 and may associate with more than one AP 105. Such a scenario is further illustrated in FIG. 2. A single AP 105 and an associated set of STAs 115 may be referred to as a BSS. An ESS is a set of connected BSSs that appear as a single BSS to a user. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

FIG. 2 illustrates an example of a wireless communications network 200 that supports station-aided spatial reuse group detection in accordance with various aspects of the present disclosure. In some examples, wireless communications network 200 may implement aspects of WLAN 100.

The wireless communications network 200 may include a first basic service set (BSS) including a first access point (AP) 105-a, a second BSS including a second AP 105-b, a third BSS including a third AP 105-c, and a fourth BSS including a fourth AP 105-d. Each of the APs 105-a through 105-d may be examples of aspects of AP 105 as described with reference to FIG. 1. The wireless communications network 200 may include a first STA 115-a, a second STA 115-b, a third STA 115-c, and a fourth STA 115-d. Each of the STAs 115-a through 115-d may be examples of aspects of STA 115 as described with reference to FIG. 1.

The first BSS (including first AP 105-a) may be a spatial reuse group (SRG) BSS. Each of the STAs 115-a through 115-d may be members of the SRG BSS. The first AP 105-a may transmit its SRG reuse parameters. The SRG reuse parameters may include an identification of a color parameter (e.g., a color code) and a group identifier (e.g., a BSS identifier (BSSID) or partial BSSID). The SRG reuse parameters may include, for example, spatial reuse control information or spatial reuse offset information for a minimum and maximum power level.

In some examples, STAs in the first BSS may utilize the first AP 105-a's SRG parameters to determine whether or not to set their NAVs. The NAV may be used to indicate the duration for which the medium is considered busy. For example, the first STA 115-a may receive a medium reservation signal such as a request to send (RTS) signal or a clear to send (CTS) signal. The medium reservation signal may include a color parameter or a group identifier for the BSS of which the transmitting device is a member. The first STA 115-a may determine whether the transmitting device is a member of the first BSS. If the transmitting device is determined to be a member of the first BSS, the first STA 115-a may set its network allocation vector (NAV) and refrain from transmitting according to a duration field of the medium reservation signal. If the transmitting device is determined not to be a member of the first BSS (e.g., because the color code in the medium reservation signal does not match the color code announced by the first AP 105-a), the first STA 115-a may not set its NAV and may transmit notwithstanding the duration field of the medium reservation signal.

The first AP 105-a may be associated with a coverage area 205. The first AP 105-a may be able to receive transmissions from devices within the coverage area 205, and may be unable to receive transmissions from devices outside of the coverage area 205. Each of the UEs in the first BSS—including the first STA 115-a, the second STA 115-b, the third STA 115-c, and the fourth STA 115-d—may be within the coverage area 205.

The first AP 105-a may transmit SRG reuse parameters for all APs within the coverage area 205 of the first AP 105-a. The SRG reuse parameters may include a color bitmap and a BSSID bitmap.

In some examples, the second AP 105-b may be within the coverage area 205 of the first AP 105-a. Therefore, when the second AP 105-b transmits its SRG reuse parameters, the first AP 105-a may receive the transmission. The SRG reuse parameters may then be included in the color bitmap and/or the BSSID bitmap provided to the STAs in the first BSS.

However, the first AP 105-a may not receive transmissions from one or more APs that are physically located outside of the coverage area 205, even though other devices operating within the coverage area 205 may receive or otherwise be affected by such transmissions. For example, the third AP 105-c may be outside of the coverage area 205. However, although transmissions from the third AP 105-c may not reach the first AP 105-a, they may reach other devices within the coverage area 205 including, for example, STA 115-c. Similarly, the fourth AP 105-d may not reach the first AP 105-a, but may reach STA 115-d. Thus, the color parameters and/or group identifiers for the third AP 105-c and fourth AP 105-d may not be included in the SRG reuse parameters by the first AP 105-a.

In order to allow the first AP 105-a to include information about such APs, the UEs in the first BSS may report color parameters and/or BSSID information to the first AP 105-a. For example, the third STA 115-c may receive a transmission from the third AP 105-c. The transmission may include a spatial reuse parameter set element including an element identifier field, a length field, an element identifier extension field, a spatial reuse control field, an offset for a minimum power, an offset for a maximum power, a field identifying the color parameter for the third AP 105-c, and a field identifying a BSSID for the third AP 105-c.

In some examples, the third STA 115-c may determine whether the AP that sends the transmission is a SRG AP that allows associated devices to use SRG reuse parameters that may be more aggressive than default values. In some examples, the third STA 115-c may identify that the third AP 105-c is a SRG AP that allows associated devices to use SRG reuse parameters that may be more aggressive than default values based at least in part on a SRG flag. For example, the SRG flag may be a SRG info present field in a spatial reuse control field of the spatial reuse parameter set element of the transmission. In some examples, the third STA 115-c may identify that the third AP 105-c is a SRG AP that allows associated devices to use SRG reuse parameters that may be more aggressive than default values based at least in part on a maximum power and/or a minimum power. The maximum power and/or minimum power may be indicated in the spatial reuse parameter set element. For example, the third STA 115-c may determine that the third AP 105-c is a SRG AP that allows associated devices to use SRG reuse parameters that may be more aggressive than default values when the maximum power is greater than −82 dBm and/or when the minimum power is greater than −62 dBm. In another example, the third STA 115-c may determine that the third AP 105-c is a SRG AP that allows associated devices to use SRG reuse parameters that may be more aggressive than default values when a maximum power offset or a minimum power offset is greater than zero. In some examples, the third STA 115-c may identify that the third AP 105-c is a SRG AP that allows associated devices to use SRG reuse parameters that may be more aggressive than default values based at least in part on a SRG definition provided by the first AP 105-a. For example, the first AP 105-a may indicate that an AP (e.g., the third AP 105-c) may be considered a SRG AP that allows associated devices to use SRG reuse parameters that may be more aggressive than default values when a maximum power is greater than x and/or a minimum power is greater than y.

The third STA 115-c may also determine whether the color parameter for the third AP 105-c and/or the BSSID for the third AP 105-c was identified in the SRG parameters transmitted by the first AP 105-a.

The third STA 115-c may report the color parameter for the third AP 105-c and/or the BSSID for the third AP 105-c to the first AP 105-a. In some examples, the third STA 115-c may periodically report this information to the first AP 105-a. In some examples, the third STA 115-c may report this information to the first AP 105-a when the third STA 115-c determines that the information was not identified in the SRG parameters transmitted by the first AP 105-a. In some examples, the third STA 115-c may report this information to the first AP 105-a based at least in part on a request from the first AP 105-a. The request may include, for example, a request identifier, a report time window, a report time deadline, a definition of SRG APs that allow associated devices to use SRG reuse parameters that may be more aggressive than default values, a configuration of report contents, or a combination thereof. The report may be configured based at least in part on the configuration of report contents. The third STA 115-c may transmit the report within the report time window or prior to the report time deadline. In some examples, the third STA 115-c may not receive a transmission from any SRG AP that allows associated devices to use SRG reuse parameters that may be more aggressive than default values whose information is not identified in the SRG reuse parameters. For example, the third STA 115-c may not transmit a periodic report, or may not transmit a report in response to the request, when no new SRG APs that allow associated devices to use SRG reuse parameters that may be more aggressive than default values are identified.

In some examples, the third STA 115-c may transmit a color bitmap and/or a partial BSSID bitmap to the first AP 105-a to report the color parameter for the third AP 105-c and/or the BSSID for the third AP 105-c. In some examples, the third STA 115-c may transmit a color index and/or a partial BSSID index to the first AP 105-a to report the color parameter for the third AP 105-c and/or the BSSID for the third AP 105-c. The third STA 115-c may also include additional information, such as the full BSSID, minimum and maximum power offsets, and the like, in the report.

The first AP 105-a may use the reported information to update the color bitmap and/or partial BSSID bitmap. In some examples, the first AP 105-a may add any new information (e.g., the color parameters and/or the partial BSSID of the third AP 105-c) to the existing color bitmap and/or partial BSSID bitmap. In some other examples, the first AP 105-a may construct a new color bitmap and/or partial BSSID bitmap by combining the reported information from each STA in the first BSS. The first AP 105-a may then transmit revised SRG reuse parameters to the STAs in the first BSS.

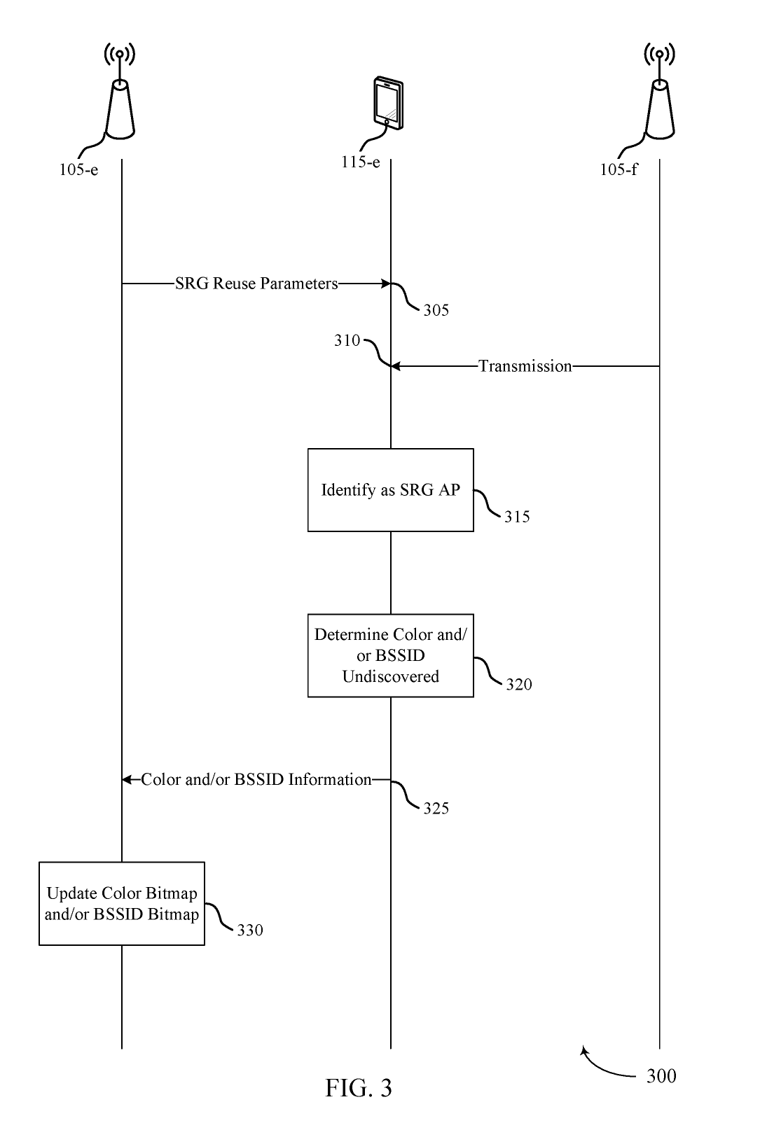

FIG. 3 illustrates an example of a flow diagram 300 for communications in a wireless communications network that supports station-aided spatial reuse group detection in accordance with various aspects of the present disclosure. In some examples, the wireless communications network may implement aspects of WLAN 100.

Flow diagram 300 illustrates communications among a first AP 105-e, a first STA 115-e, and a second AP 105-f. The first AP 105-e and second AP 105-f may be examples of aspects of AP 105 described with reference to FIG. 1. The first STA 115-e may be an example of aspects of STA 115 described with reference to FIG. 1.

The first AP 105-e and the first STA 115-e may be associated with a first SRG BSS. The second AP 105-f may be associated with a second BSS. The first AP 105-e and the second AP 105-f may be out of range of each other.

The first AP 105-e may transmit SRG reuse parameters 305 to the first STA 115-e. The SRG reuse parameters 305 may include one or more reuse parameters for spatial reuse group within the coverage area of the first AP 105-e. The SRG reuse parameters 305 may include an indication of a group identifier for an access point within the coverage area of the first AP 105-e that supports spatial reuse and allows associated devices to use SRG reuse parameters that may be more aggressive than default values. In some examples, the group identifier may identify an access point that has a SRG_OBSS_PDmin value higher than the default −82 dBm or a SRG_OBSS_PDmax value higher than the default −62 dBm.

For example, the SRG reuse parameters 305 may indicate the basic service set identifier (BSSID) or partial BSSID for the access point. In some examples, the SRG reuse parameters 305 may include an indication of a group identifier for each access point within the coverage area of the first AP 105-e that supports spatial reuse and allows associated devices to use SRG reuse parameters that may be more aggressive than default values. The one or more BSSIDs or partial BSSIDs corresponding to the access points may be indicated in a group identifier bitmap such as a BSSID bitmap or a partial BSSID bitmaps. In some other examples, the one or more BSSIDs or partial BSSIDs may be indicated by one or more group identifier indices.

The SRG reuse parameters 305 may include an indication of a color for each access point within the coverage area of the first AP 105-e that supports spatial reuse and allows associated devices to use SRG reuse parameters that may be more aggressive than default values. In some examples, the one or more colors may be indicated in a color bitmap identifying a color parameter for each such access point. In some other examples, the one or more colors may be indicated by one or more color indices, with each index corresponding to a color associated with one of the access points that supports spatial reuse.

In some examples, the first AP 105-e may periodically transmit SRG reuse parameters 305 to all STAs in the first SRG BSS. In some other examples, the first AP 105-e may transmit SRG reuse parameters to all STAs in the first SRG BSS when the SRG reuse parameters change.

The first STA 115-e may then receive a transmission 310 from the second AP 105-f. The second AP 105-f may be outside the range of the first AP 105-e, but within the range of the first STA 115-e. The transmission 310 may include a spatial reuse parameter set element.

At 315, the first STA 115-e may identify the second AP 105-f as a SRG AP that allows associated devices to use SRG reuse parameters that may be more aggressive than default values based at least in part on the transmission at 310. In some examples, the first STA 115-e may identify the second AP 105-f as a SRG AP based at least in part on a spatial reuse parameter set element in the transmission at 310. For example, the first STA 115-e may determine that the second AP 105-f is a SRG AP because the transmission 310 includes a “1” in a “SRG info present bit” in the spatial reuse parameter set element. The first STA 115-e may identify the second AP 105-f as a SRG AP that allows associated devices to use SRG reuse parameters that may be more aggressive than default values when the spatial reuse parameter set element of the transmission 310 indicates that the SRG_OBSS_PDmin is greater than the default minimum value (e.g., −82 dBm), that the SRG_OBSS_PDmax is greater than the default maximum value (e.g., −62 dBm), or a combination thereof. In some examples, the spatial reuse parameter set of the transmission 310 may indicate offsets relative to the default minimum and maximum values. In such examples, the first STA 115-e may identify the second AP 105-f as a SRG AP that allows associated devices to use SRG reuse parameters that may be more aggressive than default values when the spatial reuse parameter set element of the transmission 310 indicates that the SRG_OBSS_PDmin_offset is greater than zero, that the SRG_OBSS_PDmax_offset is greater than zero, or a combination thereof.

In some other examples, the first STA 115-e may identify the second AP 105-f as a SRG AP that allows associated devices to use SRG reuse parameters that may be more aggressive than default values based on a definition provided by the first AP 105-e. For example, the AP 105-e may indicate that the first STA 115-e should identify an access point as a SRG AP that allows associated devices to use SRG reuse parameters that may be more aggressive than default values when the access point signals a SRG_OBSS_PDmin is greater than x, that a SRG_OBSS_PDmin is greater than y, or a combination thereof.

The first STA 115-e may determine that a color and/or group identifier (e.g., partial BSSID) associated with the second AP 105-f are undiscovered, i.e., not included in the SRG reuse parameters 305, at 320. In some examples, the first STA 115-e may determine whether a color and/or BSSID associated with the second AP 105-f are undiscovered without performing an intermediate step to determine whether the second AP 105-f is an SRG AP that allows associated devices to use SRG reuse parameters that may be more aggressive than default values.

The first STA 115-e may autonomously report color and/or BSSID information 325 to the first AP 105-e based at least in part on determining that the color and/or BSSID are undiscovered. In some examples, the report may include a color bitmap identifying the color parameter of the second AP 105-f, a group identifier bitmap identifying the group identifier (e.g., partial BSSID) of the second AP 105-f, or both. The color bitmap and/or group identifier bitmap may be, for example, a 64 bit bitmap. In some examples, the report may include an index for the color parameter of the second AP 105-f, an index for the group identifier (e.g., partial BSSID) of the second AP 105-f, or both. The index may be, for example, a 6 bit index. In some examples, the report may include all color parameters and group identifiers observed by the first STA 115-e (i.e., that were included in transmissions received by the first STA 115-e) that were not included in the SRG reuse parameters 305. In some other examples, the report may include all color parameters and group identifiers observed by the first STA 115-e, without regard to whether any of the color parameters or group identifiers were included in the SRG reuse parameters 305. The color and/or BSSID information 325 may be accompanied by additional information such as detailed information in the spatial reuse parameter set of the second AP 105-f (e.g., offset information and the like).

In some other examples, the first STA 115-e may report color and/or BSSID information 325 to the first AP 105-e upon determining that a transmission (e.g., transmission 310) indicates that the associated access point (e.g., second AP 105-f) is a SRG AP that allows associated devices to use SRG reuse parameters that may be more aggressive than default values and the color and/or bitmap information was not signaled by the first AP 105-e (e.g., in the SRG reuse parameters 305). In some examples, the first STA 115-e may not report information when an access point is not a SRG AP, e.g., when a ‘0’ is identified in the “SRG info present” bit. In some examples, the first STA 115-e may not report information when an access point is a SRG AP, e.g., when a ‘1’ is identified in the “SRG info present” bit, but the access point does not allow associated devices to use SRG reuse parameters that may be more aggressive than default values, e.g., when the offset field(s) have a value of zero.

The first AP 105-e may then update the color bitmap and/or BSSID bitmap based at least in part on the color and/or BSSID information 325 at 330. In some examples, the first AP 105-e may use the information from the SRG reuse parameters 305 and add any additional color parameters and/or group identifiers included in the report (e.g., the color parameter and/or BSSID information of the second AP 105-f) thereto. In some other examples, the first AP 105-e may construct new bitmaps based at least in part on the color and/or BSSID information 325. For example, the first AP 105-e may construct new bitmaps based on the union of bitmaps received from all UEs in the first BSS (including the first STA 115-e).

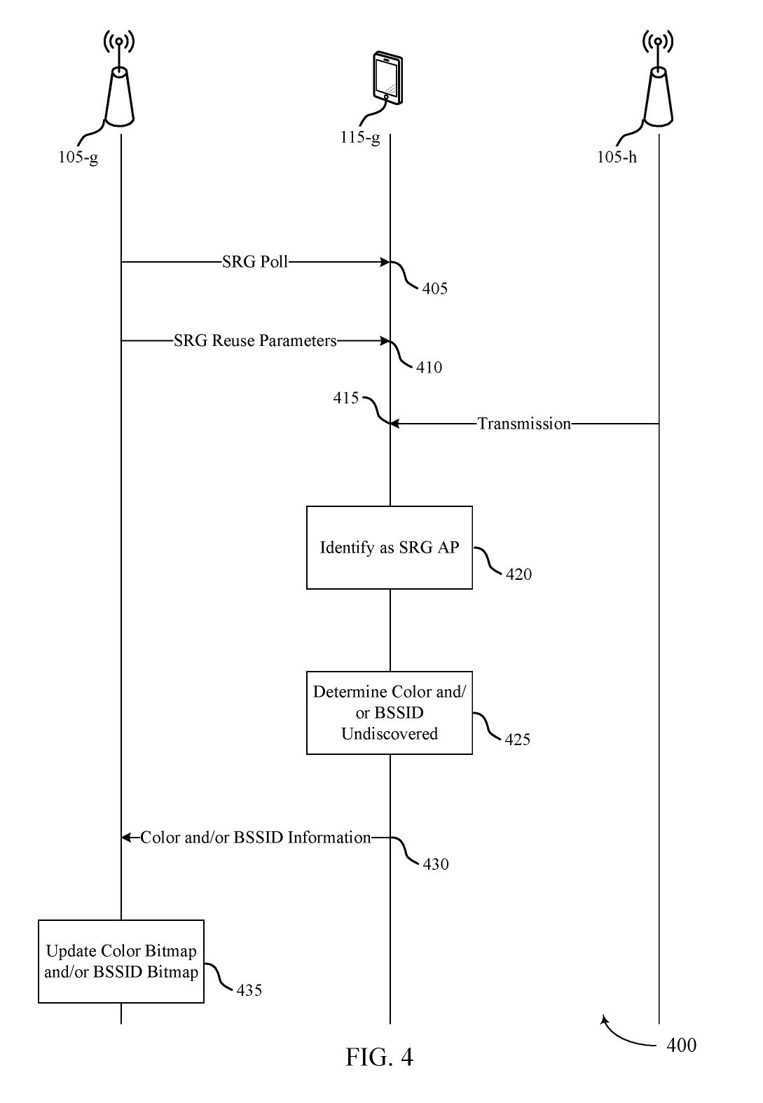

FIG. 4 illustrates an example of a flow diagram 400 for communications in a wireless communications network that supports station-aided spatial reuse group detection in accordance with various aspects of the present disclosure. In some examples, the wireless communications network may implement aspects of WLAN 100.

Flow diagram 400 illustrates communications among a first AP 105-g, a first STA 115-g, and a second AP 105-h. The first AP 105-g and second AP 105-h may be examples of aspects of AP 105 described with reference to FIG. 1. The first STA 115-g may be an example of aspects of STA 115 described with reference to FIG. 1.

The first AP 105-g and the first STA 115-g may be associated with a first SRG BSS. The second AP 105-h may be associated with a second BSS. The first AP 105-g and the second AP 105-h may be out of range of each other.

The first STA 115-g may receive a SRG poll 405. The SRG poll 405 may include a request identifier, a report time window, a report time deadline, a definition of SRG BSSs, a configuration of report contents, or a combination thereof. The first STA 115-g may use the definition of SRG BSSs to identify whether the second AP 105-h is a SRG AP.

The first AP 105-g may transmit SRG reuse parameters 410 to the first STA 115-g, as described with reference to reference numeral 305 in FIG. 3. In some examples, the first AP 105-g may periodically transmit SRG reuse parameters 410 to all STAs in the first SRG BSS.

The first STA 115-g may receive a transmission 415 from the second AP 105-h, as described with reference to reference number 310 in FIG. 3. The first STA 115-g may identify the second AP 105-h as a SRG AP that allows associated devices to use SRG reuse parameters that may be more aggressive than default values based at least in part on the transmission 415 at 420, as described with reference to reference number 315 in FIG. 3. In some examples, the first STA 115-g may identify the second AP 105-h as a SRG AP that allows associated devices to use SRG reuse parameters that may be more aggressive than default values based at least in part on the definition of SRG BSSs provided in the SRG poll 405. In some examples, the first STA 115-g may identify the second AP 105-h as a SRG AP that allows associated devices to use SRG reuse parameters that may be more aggressive than default values based at least in part on offset values identified in the SRG poll 405.

The first STA 115-g may determine that a color and/or BSSID associated with the second AP 105-h are undiscovered, i.e., not included in the SRG reuse parameters 410, at 425. In some examples, the first STA 115-g may determine whether a color and/or BSSID associated with the second AP 105-h are undiscovered without performing an intermediate step to determine whether the second AP 105-h is an SRG AP that allows associated devices to use SRG reuse parameters that may be more aggressive than default values.

The first STA 115-g may report color and/or BSSID information 430 to the first AP 105-g based at least in part on receipt of the SRG poll 425. The report may be configured based at least in part on the configuration of report contents identified in the SRG poll 425. In some examples, the report may be transmitted before a report time deadline indicated in the SRG poll 425. In some examples, the report may be transmitted within a report time window indicated in the SRG poll 425.

The first AP 105-g may then update the color bitmap and/or BSSID bitmap based at least in part on the color and/or BSSID information 430 at 435. The first AP 105-g may update the bitmaps by adding new information to the existing bitmaps based at least in part on the color and/or BSSID information 430, or by constructing new bitmaps based at least in part on the color and/or BSSID information 430.

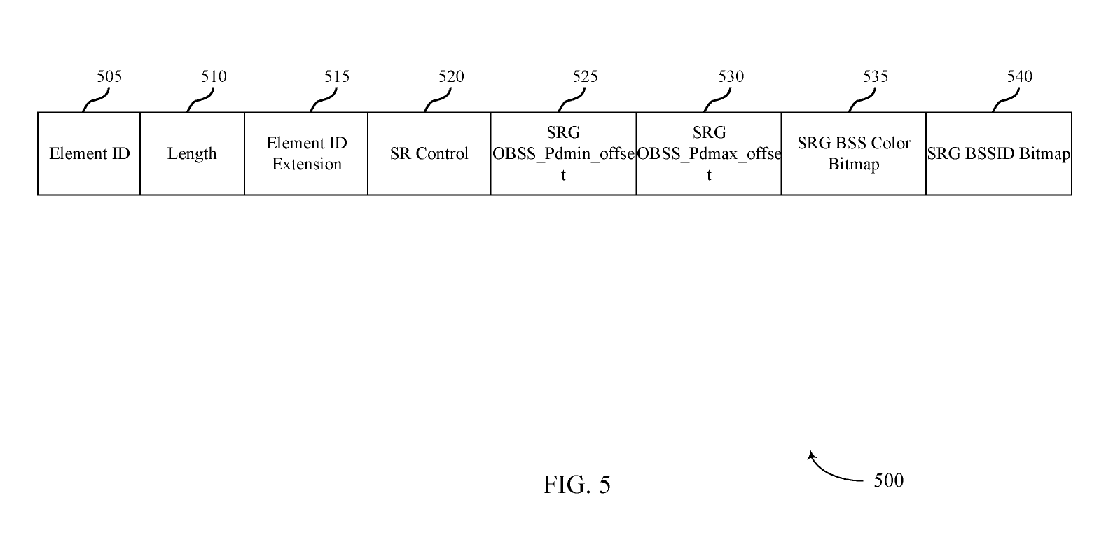

FIG. 5 illustrates an example of a spatial reuse element 500 for use in communications in a wireless communications network that supports station-aided spatial reuse group detection in accordance with various aspects of the present disclosure. In some examples, a WLAN 100 or wireless communications network 200, as described above, may implement spatial reuse element 500.

The spatial reuse element 500 may be also be referred to as a parameter set and may be an example of information provided as part of the SRG reuse parameters 305 and 405 described with reference to FIGS. 3 and 4. The spatial reuse element 500 may also be an example of information provided as part of transmissions 310 and 410 as described with reference to FIGS. 3 and 4.

The spatial reuse element 500 may include an element identifier (ID) 505, a length 510, an element identifier extension 515, a SR control 520, a SRG Minimum Power Offset 525, a SRG Maximum Power Offset 530, a SRG BSS color bitmap 535, and a SRG BSSID bitmap 540.

The element identifier 505 may include a reference number for the spatial reuse parameter set element. In some examples, the reference number may indicate that the element is a spatial reuse parameter set element. The element identifier extension 515 may include additional information about the spatial reuse parameter set element. The length field 510 may indicate the length of the spatial reuse parameter set element.

The SR control 520 may have 8 bits. In some examples, one of the bits in the SR control 520 may be an SRG information present bit. The SRG information present bit may be 1 when the transmitting AP is an SRG AP, and may be 0 otherwise. A STA such as STA 115-e or STA 115-g described with reference to FIGS. 3 and 4 may use the SRG present bit to determine whether a transmission was sent by a SRG AP.

The SRG Minimum Power Offset 525 may indicate an offset (SRG_OBSS_PDmin_offset) for the SRG minimum power relative to a default value for the minimum power (e.g., −62 dBm). The SRG Maximum Power Offset 530 may indicate an offset (SRG_OBSS_PDmax_offset) for the SRG maximum power relative to a default maximum power (e.g., −82 dBm). A STA such as STA 115-e or STA 115-g described with reference to FIGS. 3 and 4 may use the SRG Minimum Power Offset 525 and/or the SRG Maximum Power Offset 530 to determine whether a transmission was sent by a SRG AP that allows associated devices to use SRG reuse parameters that may be more aggressive than default values. For example, a STA such as STA 115-e described with reference to FIG. 3 may determine that a transmitting AP is a SRG AP that allows associated devices to use SRG reuse parameters that may be more aggressive than default values when the SRG Minimum Power Offset 525 and/or the SRG Maximum Power Offset 530 has a value greater than zero. In some other examples, a STA such as STA 115-e described with reference to FIG. 3 may determine that a transmitting AP is a SRG AP that allows associated devices to use SRG reuse parameters that may be more aggressive than default values when the SRG Minimum Power Offset 525 and/or the SRG Maximum Power Offset 530 has a value greater than a value specified by an AP such as first AP 105-e described with reference to FIG. 3. The specified value may be included in a SRG poll such as SRG poll 425 described with reference to FIG. 4.

The SRG BSS color bitmap 535 may have 64 bits corresponding to 64 available colors. A bit “1” means the corresponding color has been used by at least one SRG BSS, while a bit “0” indicates that the corresponding color has not been used by at least one SRG BSS.

The SRG BSSID bitmap 540 may have 64 bits corresponding to 64 available BSSIDs. A bit “1” indicates that the corresponding BSSID value is used by at least one SRG BSS, while a bit “0” indicates that the corresponding BSSID value is not used by at least one SRG BSS. In some examples, each of the bits in the SRG BSSID bitmap 540 may correspond to a partial bitmap.

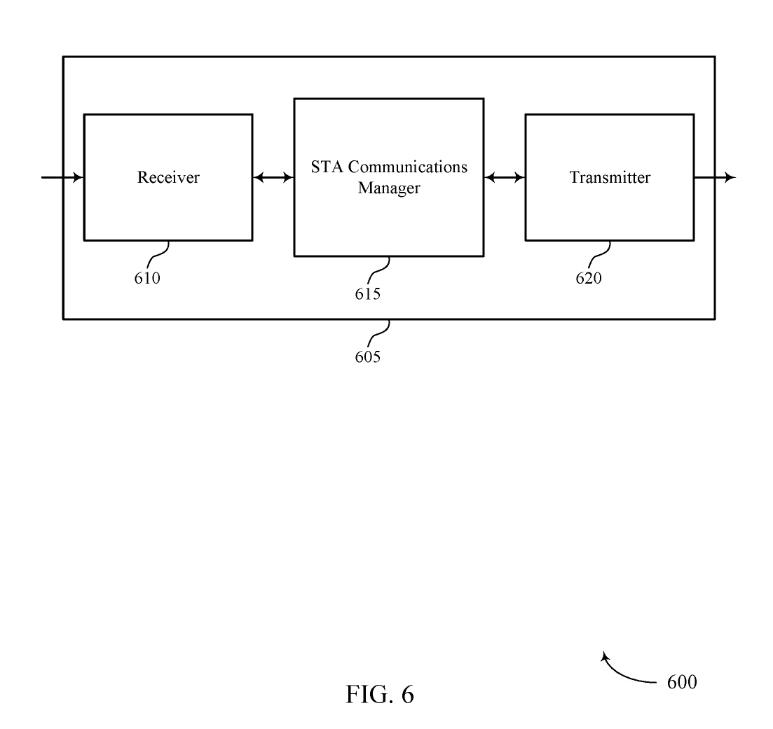

FIG. 6 shows a block diagram 600 of a wireless device 605 that supports station-aided spatial reuse group detection in accordance with aspects of the present disclosure. Wireless device 605 may be an example of aspects of a station (STA) 115 as described herein. Wireless device 605 may include receiver 610, STA communications manager 615, and transmitter 620. Wireless device 605 may also include a processor. Each of these components may be in communication with one another (e.g., via one or more buses).

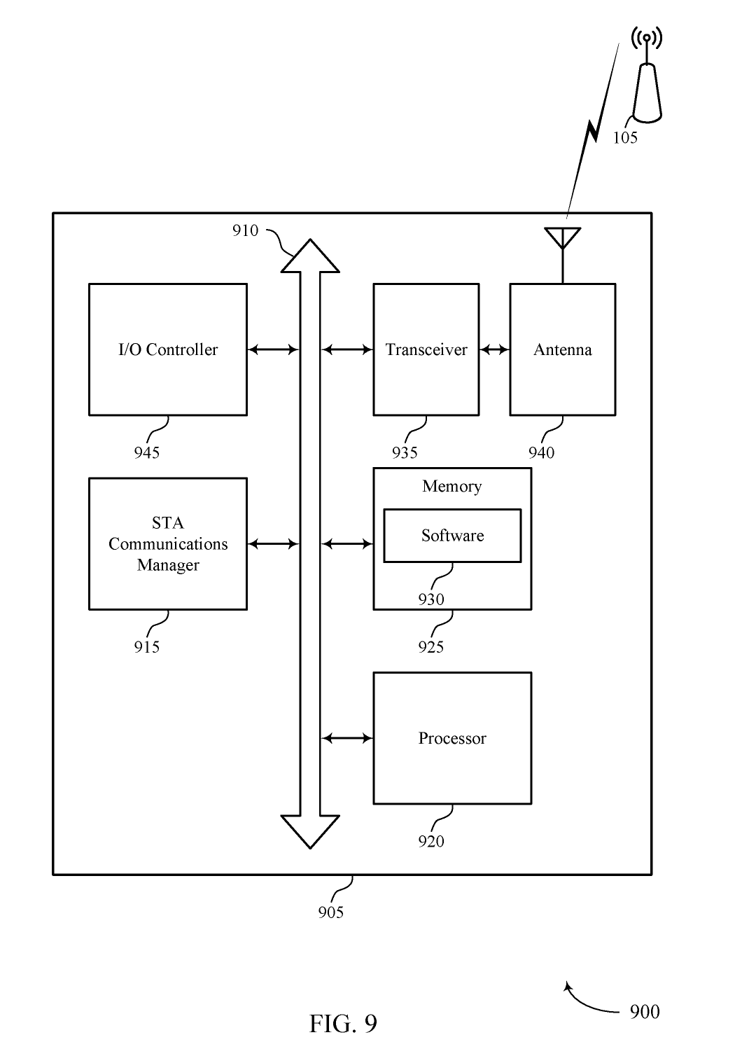

Receiver 610 may receive information such as packets, user data, or control information associated with various information channels (e.g., control channels, data channels, and information related to station-aided spatial reuse group detection, etc.). Information may be passed on to other components of the device. The receiver 610 may be an example of aspects of the transceiver 935 described with reference to FIG. 9. The receiver 610 may utilize a single antenna or a set of antennas.

Receiver 610 may receive, by a STA associated with a first access point (AP), a transmission from a second AP, receive updated information indicative of one or more parameters of spatial reuse groups within a coverage area of the first AP, the updated information indicative of the one or more parameters of the spatial reuse groups including the one or more parameters for the spatial reuse group, receive, from the first AP, a request to report one or more parameters of spatial reuse groups within a coverage area of the STA, receive, from the first AP, a spatial reuse definition, receive, from the first AP, information indicative of one or more parameters of spatial reuse groups within a coverage area of the first AP, receive, from the first AP, a spatial reuse report request, the spatial reuse report request including at least one of a request identifier, a report response time, a spatial reuse definition, and a report configuration, and receive a second transmission from a third AP. In some cases, the identifier for the second AP includes a partial identifier for the second AP. In some cases, the one or more parameters of the second AP includes at least one of a color bitmap identifying the color parameter of the second AP or a partial BSSID identifier bitmap identifying the partial BSSID of the second AP. In some cases, the identifier for the second AP includes a full BSSID of the second AP. In some cases, the one or more parameters of the second AP includes at least one of a signal strength minimum offset for the second AP, a signal strength maximum offset for the second AP, and spatial reuse control information for the second AP. In some cases, the one or more parameters of the second AP includes at least one of a color index corresponding to the color parameter of the second AP and a group identifier index of the second AP.

STA communications manager 615 may be an example of aspects of the STA communications manager 915 described with reference to FIG. 9.

STA communications manager 615 and/or at least some of its various sub-components may be implemented in hardware, software executed by a processor, firmware, or any combination thereof. If implemented in software executed by a processor, the functions of the STA communications manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The STA communications manager 615 and/or at least some of its various sub-components may be physically located at various positions, including being distributed such that portions of functions are implemented at different physical locations by one or more physical devices. In some examples, STA communications manager 615 and/or at least some of its various sub-components may be a separate and distinct component in accordance with various aspects of the present disclosure. In other examples, STA communications manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

STA communications manager 615 may determine that the second AP is a member of a spatial reuse group based on receiving the transmission and transmit, to the first AP, one or more parameters of the second AP, the one or more parameters including at least one of a color parameter for the second AP or an identifier for the second AP.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may utilize a single antenna or a set of antennas.

Transmitter 620 may transmit the one or more parameters of the spatial reuse group to the first AP includes periodically transmitting the one or more parameters of the spatial reuse group to the first AP.

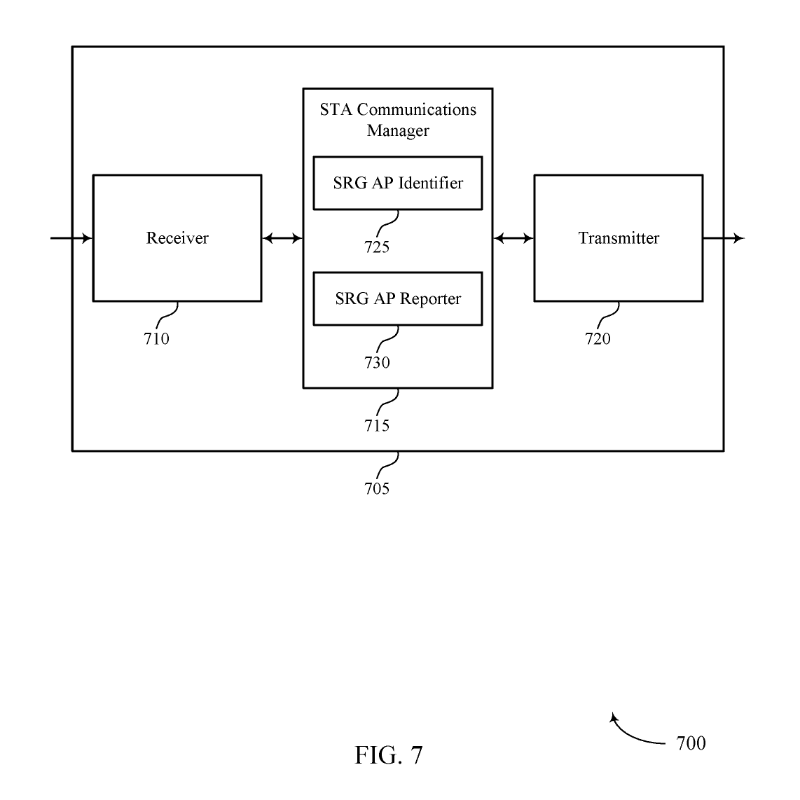

FIG. 7 shows a block diagram 700 of a wireless device 705 that supports station-aided spatial reuse group detection in accordance with aspects of the present disclosure. Wireless device 705 may be an example of aspects of a wireless device 605 or a STA 115 as described with reference to FIG. 6. Wireless device 705 may include receiver 710, STA communications manager 715, and transmitter 720. Wireless device 705 may also include a processor. Each of these components may be in communication with one another (e.g., via one or more buses).

Receiver 710 may receive information such as packets, user data, or control information associated with various information channels (e.g., control channels, data channels, and information related to station-aided spatial reuse group detection, etc.). Information may be passed on to other components of the device. The receiver 710 may be an example of aspects of the transceiver 935 described with reference to FIG. 9. The receiver 710 may utilize a single antenna or a set of antennas.

STA communications manager 715 may be an example of aspects of the STA communications manager 915 described with reference to FIG. 9.

STA communications manager 715 may also include SRG AP identifier 725 and SRG AP reporter 730.

SRG AP identifier 725 may determine that the second AP is a member of a spatial reuse group based on receiving the transmission, determine that the second AP is a member of a spatial reuse group based on a spatial reuse group info presence flag in the transmission, determine that the second AP is a member of a spatial reuse group based on a spatial reuse signal strength maximum or a spatial reuse signal strength minimum identified in the transmission, determine that the second AP is a member of a spatial reuse group based on the spatial reuse definition, and determine that the third AP is not a member of any spatial reuse group based on receiving the second transmission.

SRG AP reporter 730 may transmit, to the first AP, one or more parameters of the second AP, the one or more parameters including at least one of a color parameter for the second AP or an identifier for the second AP, transmit the one or more parameters of the second AP to the first AP based on the determining that the at least one of the color parameter or the identifier is unknown to the first AP, transmit the one or more parameters of the second AP to the first AP based on the request, transmit the one or more parameters of the spatial reuse group based on the reuse report request, and determine not to report spatial reuse parameters of the third AP based on determining that the third AP is not a member of any spatial reuse group.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may utilize a single antenna or a set of antennas.

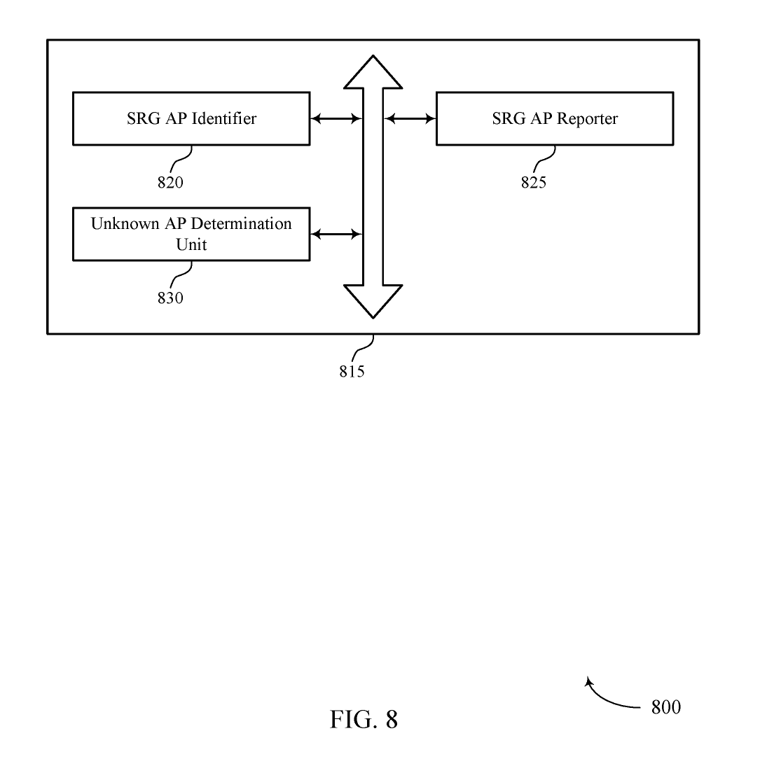

FIG. 8 shows a block diagram 800 of a STA communications manager 815 that supports station-aided spatial reuse group detection in accordance with aspects of the present disclosure. The STA communications manager 815 may be an example of aspects of a STA communications manager 615, a STA communications manager 715, or a STA communications manager 915 described with reference to FIGS. 6, 7, and 9. The STA communications manager 815 may include SRG AP identifier 820, SRG AP reporter 825, and unknown AP determination unit 830. Each of these modules may communicate, directly or indirectly, with one another (e.g., via one or more buses).

SRG AP identifier 820 may determine that the second AP is a member of a spatial reuse group based on receiving the transmission, determine that the second AP is a member of a spatial reuse group based on a spatial reuse group info presence flag in the transmission, determine that the second AP is a member of a spatial reuse group based on a spatial reuse signal strength maximum or a spatial reuse signal strength minimum identified in the transmission, determine that the second AP is a member of a spatial reuse group based on the spatial reuse definition, and determine that the third AP is not a member of any spatial reuse group based on receiving the second transmission.

SRG AP reporter 825 may transmit, to the first AP, one or more parameters of the second AP, the one or more parameters including at least one of a color parameter for the second AP or an identifier for the second AP, transmit the one or more parameters of the second AP to the first AP based on the determining that the at least one of the color parameter or the identifier is unknown to the first AP, transmit the one or more parameters of the second AP to the first AP based on the request, transmit the one or more parameters of the spatial reuse group based on the reuse report request, and determine not to report spatial reuse parameters of the third AP based on determining that the third AP is not a member of any spatial reuse group.

Unknown AP determination unit 830 may determine, based on the transmission, that the at least one of the color parameter or the identifier for the second AP is unknown to the first AP.

FIG. 9 shows a diagram of a system 900 including a device 905 that supports station-aided spatial reuse group detection in accordance with aspects of the present disclosure. Device 905 may be an example of or include the components of wireless device 605, wireless device 705, or a STA 115 as described above, e.g., with reference to FIGS. 6 and 7. Device 905 may include components for bi-directional voice and data communications including components for transmitting and receiving communications, including STA communications manager 915, processor 920, memory 925, software 930, transceiver 935, antenna 940, and I/O controller 945. These components may be in electronic communication via one or more buses (e.g., bus 910).

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting station-aided spatial reuse group detection).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support station-aided spatial reuse group detection. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with device 905 via I/O controller 945 or via hardware components controlled by I/O controller 945.

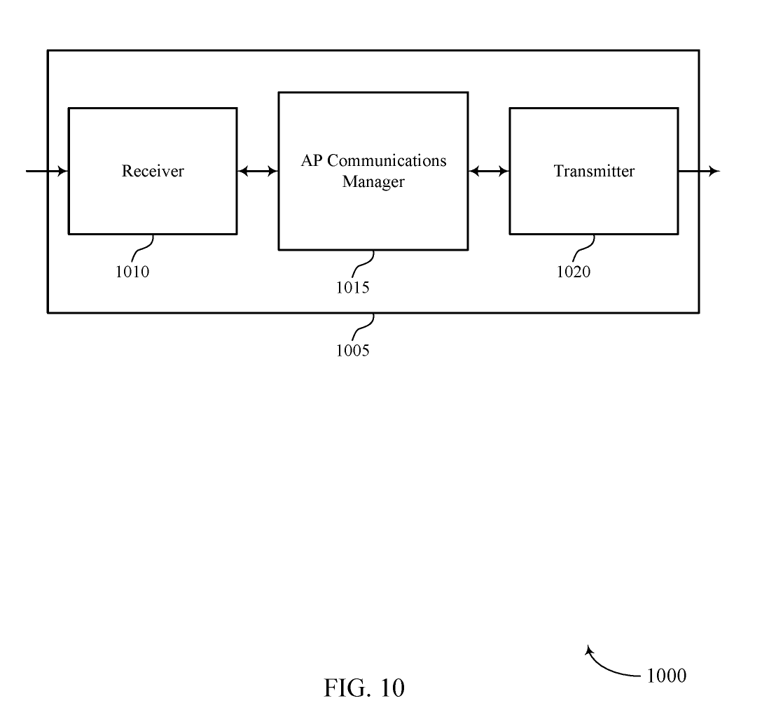

FIG. 10 shows a block diagram 1000 of a wireless device 1005 that supports station-aided spatial reuse group detection in accordance with aspects of the present disclosure. Wireless device 1005 may be an example of aspects of a AP 105 as described herein. Wireless device 1005 may include receiver 1010, AP communications manager 1015, and transmitter 1020. Wireless device 1005 may also include a processor. Each of these components may be in communication with one another (e.g., via one or more buses).

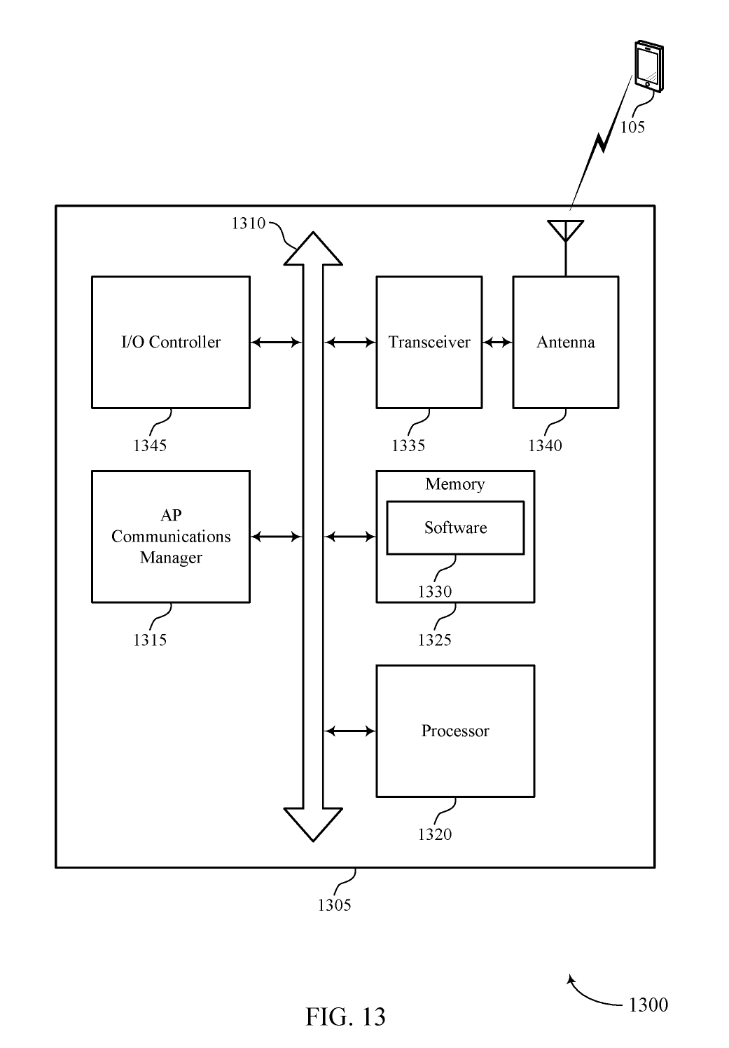

Receiver 1010 may receive information such as packets, user data, or control information associated with various information channels (e.g., control channels, data channels, and information related to station-aided spatial reuse group detection, etc.). Information may be passed on to other components of the device. The receiver 1010 may be an example of aspects of the transceiver 1335 described with reference to FIG. 13. The receiver 1010 may utilize a single antenna or a set of antennas.

Receiver 1010 may receive, from a STA of the set of STAs in the BSS, second spatial reuse information that includes at least one of a color or an identifier of a third AP in the spatial reuse group and receive the second spatial reuse information based on the request to report spatial reuse information. In some cases, the second spatial reuse information includes at least one of a color bitmap identifying a color parameter for the second AP and an identifier for the second AP. In some cases, the second spatial reuse information includes at least one of a color index corresponding to the color parameter for the second AP and a identifier index corresponding to the identifier for the second AP.

AP communications manager 1015 may be an example of aspects of the AP communications manager 1315 described with reference to FIG. 13.

AP communications manager 1015 and/or at least some of its various sub-components may be implemented in hardware, software executed by a processor, firmware, or any combination thereof. If implemented in software executed by a processor, the functions of the AP communications manager 1015 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The AP communications manager 1015 and/or at least some of its various sub-components may be physically located at various positions, including being distributed such that portions of functions are implemented at different physical locations by one or more physical devices. In some examples, AP communications manager 1015 and/or at least some of its various sub-components may be a separate and distinct component in accordance with various aspects of the present disclosure. In other examples, AP communications manager 1015 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

AP communications manager 1015 may generate third spatial reuse information based on the second spatial reuse information received from the STA.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1335 described with reference to FIG. 13. The transmitter 1020 may utilize a single antenna or a set of antennas.

Transmitter 1020 may transmit, by an AP, first spatial reuse information to a set of stations (STAs) in a basic service set (BSS) including the AP, the first spatial reuse information including at least one a color or an identifier of a second AP in a spatial reuse group having a coverage area that overlaps a coverage area of the first AP, transmit a request to report spatial reuse information to the set of STAs in the BSS, transmit a spatial reuse definition to the set of STAs in the BSS, and transmit a report request including a spatial reuse report time to the STA.

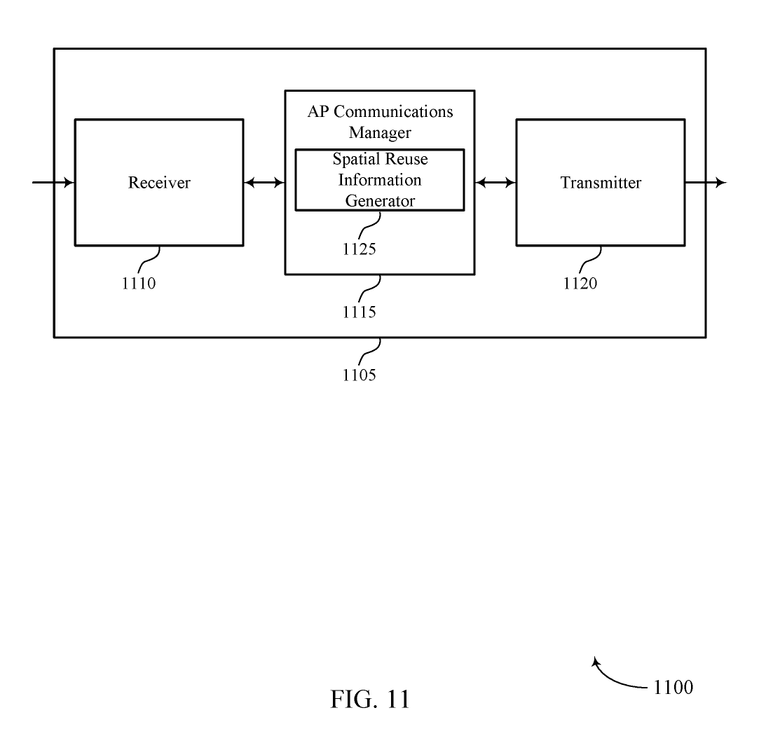

FIG. 11 shows a block diagram 1100 of a wireless device 1105 that supports station-aided spatial reuse group detection in accordance with aspects of the present disclosure. Wireless device 1105 may be an example of aspects of a wireless device 1005 or a AP 105 as described with reference to FIG. 10. Wireless device 1105 may include receiver 1110, AP communications manager 1115, and transmitter 1120. Wireless device 1105 may also include a processor. Each of these components may be in communication with one another (e.g., via one or more buses).

Receiver 1110 may receive information such as packets, user data, or control information associated with various information channels (e.g., control channels, data channels, and information related to station-aided spatial reuse group detection, etc.). Information may be passed on to other components of the device. The receiver 1110 may be an example of aspects of the transceiver 1335 described with reference to FIG. 13. The receiver 1110 may utilize a single antenna or a set of antennas.

AP communications manager 1115 may be an example of aspects of the AP communications manager 1315 described with reference to FIG. 13.

AP communications manager 1115 may also include spatial reuse information generator 1125.

Spatial reuse information generator 1125 may generate third spatial reuse information based on the second spatial reuse information received from the STA, create the third spatial reuse information based on the second spatial reuse information and additional spatial reuse information provided by other STAs of the set of STAs in the BSS, and create the third spatial reuse information by updating the first spatial reuse information based on the second spatial reuse information.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1335 described with reference to FIG. 13. The transmitter 1120 may utilize a single antenna or a set of antennas.

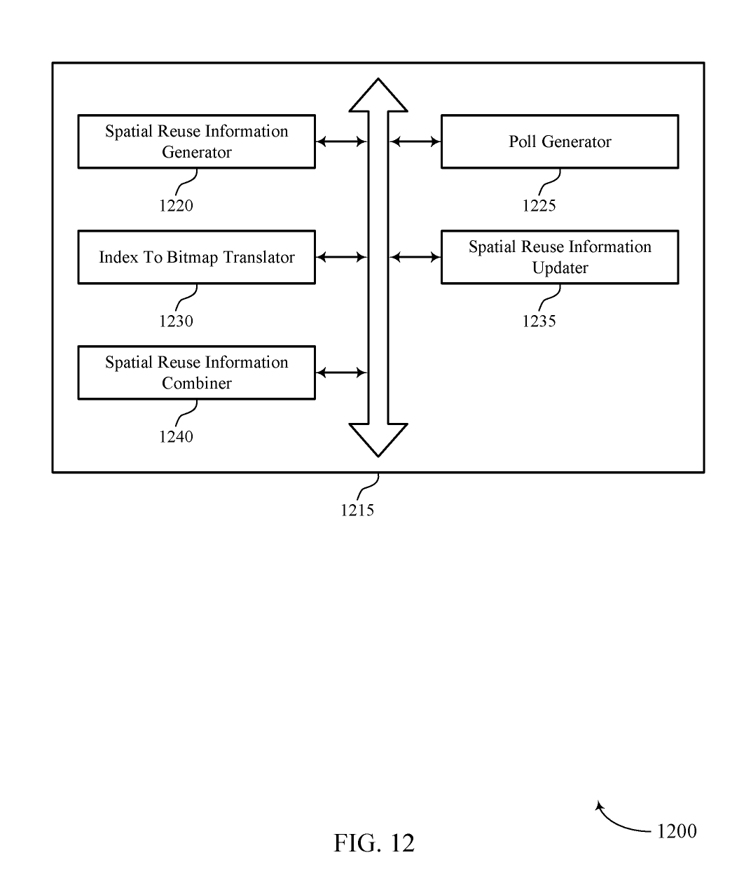

FIG. 12 shows a block diagram 1200 of a AP communications manager 1215 that supports station-aided spatial reuse group detection in accordance with aspects of the present disclosure. The AP communications manager 1215 may be an example of aspects of a AP communications manager 1015 and/or 1115 described with reference to FIGS. 10 and 11. The AP communications manager 1215 may include spatial reuse information generator 1220, poll generator 1225, index to bitmap translator 1230, spatial reuse information updater 1235, and spatial reuse information combiner 1240. Each of these modules may communicate, directly or indirectly, with one another (e.g., via one or more buses).

Spatial reuse information generator 1220 may generate third spatial reuse information based at least in part on the second spatial reuse information received from the STA.

Poll generator 1225 may transmit a request to report spatial reuse information to the set of STAs in the BSS, transmit a spatial reuse definition to the set of STAs in the BSS, and transmit a report request including a spatial reuse report time to the STA.

Index to bitmap translator 1230 may translate index information into bitmap information. In some cases, the second spatial reuse information includes at least one of a color index corresponding to the color parameter for the second AP and a identifier index corresponding to the identifier for the second AP.

Spatial reuse information updater 1235 may create the third spatial reuse information based on the second spatial reuse information and additional spatial reuse information provided by other STAs of the set of STAs in the BSS.

Spatial reuse information combiner 1240 may create the third spatial reuse information by updating the first spatial reuse information based on the second spatial reuse information.

In some examples, spatial reuse information updater 1235 and/or spatial reuse information combiner 1240 may be components of spatial reuse information generator 1220.

FIG. 13 shows a diagram of a system 1300 including a device 1305 that supports station-aided spatial reuse group detection in accordance with aspects of the present disclosure. Device 1305 may be an example of or include the components of AP 105 as described above, e.g., with reference to FIG. 1. Device 1305 may include components for bi-directional voice and data communications including components for transmitting and receiving communications, including AP communications manager 1315, processor 1320, memory 1325, software 1330, transceiver 1335, antenna 1340, and I/O controller 1345. These components may be in electronic communication via one or more buses (e.g., bus 1310).

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting station-aided spatial reuse group detection).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware or software operation such as the interaction with peripheral components or devices.

Software 1330 may include code to implement aspects of the present disclosure, including code to support station-aided spatial reuse group detection. Software 1330 may be stored in a non-transitory computer-readable medium such as system memory or other memory. In some cases, the software 1330 may not be directly executable by the processor but may cause a computer (e.g., when compiled and executed) to perform functions described herein.

Transceiver 1335 may communicate bi-directionally, via one or more antennas, wired, or wireless links as described above. For example, the transceiver 1335 may represent a wireless transceiver and may communicate bi-directionally with another wireless transceiver. The transceiver 1335 may also include a modem to modulate the packets and provide the modulated packets to the antennas for transmission, and to demodulate packets received from the antennas.

In some cases, the wireless device may include a single antenna 1340. However, in some cases the device may have more than one antenna 1340, which may be capable of concurrently transmitting or receiving multiple wireless transmissions.

I/O controller 1345 may manage input and output signals for device 1305. I/O controller 1345 may also manage peripherals not integrated into device 1305. In some cases, I/O controller 1345 may represent a physical connection or port to an external peripheral. In some cases, I/O controller 1345 may utilize an operating system such as iOS®, ANDROID®, MS-DOS®, MS-WINDOWS®, OS/2®, UNIX®, LINUX®, or another known operating system. In other cases, I/O controller 1345 may represent or interact with a modem, a keyboard, a mouse, a touchscreen, or a similar device. In some cases, I/O controller 1345 may be implemented as part of a processor. In some cases, a user may interact with device 1305 via I/O controller 1345 or via hardware components controlled by I/O controller 1345.

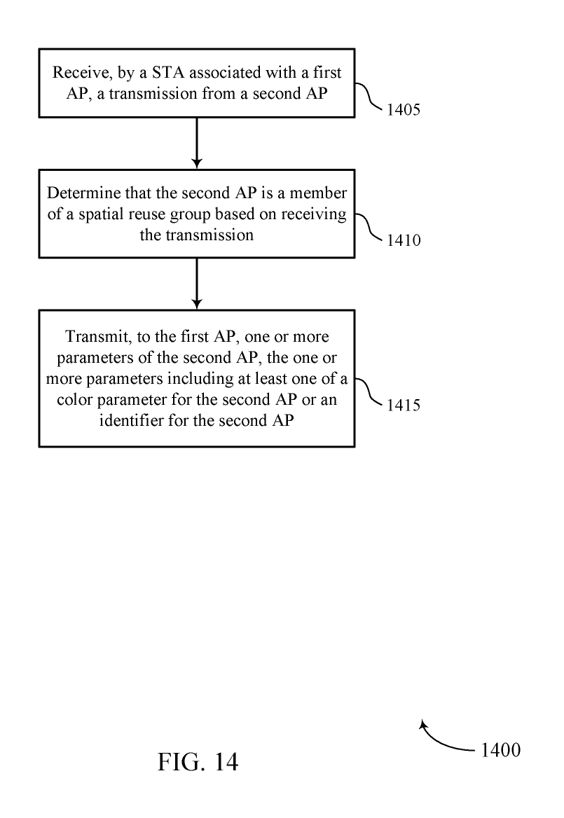

FIG. 14 shows a flowchart illustrating a method 1400 for station-aided spatial reuse group detection in accordance with aspects of the present disclosure. The operations of method 1400 may be implemented by a STA 115 or its components as described herein. For example, the operations of method 1400 may be performed by a STA communications manager as described with reference to FIGS. 6 through 9. In some examples, a STA 115 may execute a set of codes to control the functional elements of the device to perform the functions described below. Additionally or alternatively, the STA 115 may perform aspects of the functions described below using special-purpose hardware.

At block 1405 the STA 115 may receive, by a station (STA) associated with a first access point (AP), a transmission from a second AP. The operations of block 1405 may be performed according to the methods described herein. In certain examples, aspects of the operations of block 1405 may be performed by a receiver as described with reference to FIGS. 6 through 9.

At block 1410 the STA 115 may determine that the second AP is a member of a spatial reuse group based at least in part on receiving the transmission. The operations of block 1410 may be performed according to the methods described herein. In certain examples, aspects of the operations of block 1410 may be performed by a SRG AP identifier as described with reference to FIGS. 6 through 9.

At block 1415 the STA 115 may transmit, to the first AP, one or more parameters of the second AP, the one or more parameters comprising at least one of a color parameter for the second AP or an identifier for the second AP. The operations of block 1415 may be performed according to the methods described herein. In certain examples, aspects of the operations of block 1415 may be performed by a SRG AP reporter as described with reference to FIGS. 6 through 9.

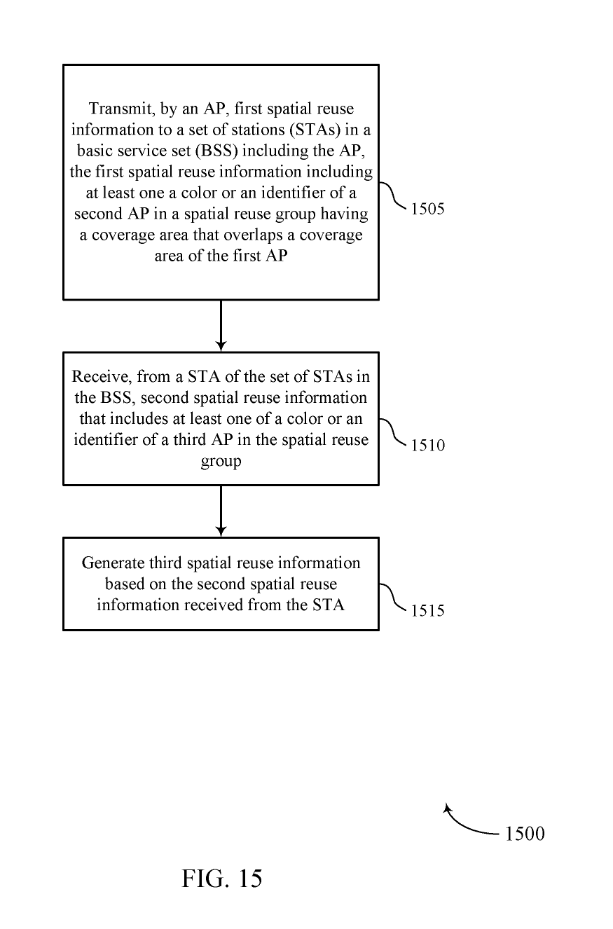

FIG. 15 shows a flowchart illustrating a method 1500 for station-aided spatial reuse group detection in accordance with aspects of the present disclosure. The operations of method 1500 may be implemented by a AP 105 or its components as described herein. For example, the operations of method 1500 may be performed by a AP communications manager as described with reference to FIGS. 10 through 13. In some examples, a AP 105 may execute a set of codes to control the functional elements of the device to perform the functions described below. Additionally or alternatively, the AP 105 may perform aspects of the functions described below using special-purpose hardware.

At block 1505 the AP 105 may transmit, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP. The operations of block 1505 may be performed according to the methods described herein. In certain examples, aspects of the operations of block 1505 may be performed by a transmitter as described with reference to FIGS. 10 through 13.

At block 1510 the AP 105 may receive, from a STA of the plurality of STAs in the BSS, second spatial reuse information that comprises at least one of a color or an identifier of a third AP in the spatial reuse group. The operations of block 1510 may be performed according to the methods described herein. In certain examples, aspects of the operations of block 1510 may be performed by a receiver as described with reference to FIGS. 10 through 13.

At block 1515 the AP 105 may generate third spatial reuse information based at least in part on the second spatial reuse information received from the STA. The operations of block 1515 may be performed according to the methods described herein. In certain examples, aspects of the operations of block 1515 may be performed by a spatial reuse information generator as described with reference to FIGS. 10 through 13.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 of FIG. 1 and wireless communications network 200 of FIG. 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving, by a station (STA) associated with a first access point (AP), a transmission from a second AP;
determining that the second AP is a member of a spatial reuse group based at least in part on receiving the transmission; and
transmitting, to the first AP, one or more parameters of the second AP, the one or more parameters comprising at least one of a color parameter for the second AP or an identifier for the second AP.

2. The method of claim 1, further comprising:
receiving, from the first AP, information indicative of one or more parameters of spatial reuse groups within a coverage area of the first AP.

3. The method of claim 1, further comprising:
determining, based at least in part on the transmission, that the at least one of the color parameter or the identifier for the second AP is unknown to the first AP; and
transmitting the one or more parameters of the second AP to the first AP based at least in part on the determining that the at least one of the color parameter or the identifier is unknown to the first AP.

4. The method of claim 1, further comprising:
receiving, from the first AP, a request to report one or more parameters of spatial reuse groups within a coverage area of the STA; and
transmitting the one or more parameters of the second AP to the first AP based at least in part on the request.

5. The method of claim 1, further comprising:
determining that the second AP is a member of a spatial reuse group based at least in part on a spatial reuse group info presence flag in the transmission.

6. The method of claim 1, further comprising:
determining that the second AP is a member of a spatial reuse group based at least in part on a spatial reuse signal strength maximum or a spatial reuse signal strength minimum identified in the transmission.

7. The method of claim 1, further comprising:
receiving, from the first AP, a spatial reuse definition; and
determining that the second AP is a member of a spatial reuse group based at least in part on the spatial reuse definition.

8. The method of claim 1, wherein:
the identifier for the second AP comprises a partial identifier for the second AP.

9. The method of claim 1, wherein:
the one or more parameters of the second AP comprises at least one of a color bitmap identifying the color parameter of the second AP or a partial BSSID identifier bitmap identifying a partial BSSID of the second AP.

10. The method of claim 1, wherein:
the one or more parameters of the second AP comprises at least one of a color index corresponding to the color parameter of the second AP or a group identifier index of the second AP.

11. The method of claim 1, wherein:
the identifier for the second AP comprises a full BSSID of the second AP.

12. The method of claim 1, wherein:
the one or more parameters of the second AP comprises at least one of a signal strength minimum offset for the second AP, a signal strength maximum offset for the second AP, or spatial reuse control information for the second AP.

13. The method of claim 1, further comprising:
receiving, from the first AP, a spatial reuse report request, the spatial reuse report request comprising at least one of a request identifier, a report response time, a spatial reuse definition, or a report configuration; and
transmitting the one or more parameters of the spatial reuse group based at least in part on the reuse report request.

14. A method for wireless communication, comprising:
transmitting, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP;
receiving, from a STA of the plurality of STAs in the BSS, second spatial reuse information that comprises at least one of a color or an identifier of a third AP in the spatial reuse group; and
generating third spatial reuse information based at least in part on the second spatial reuse information received from the STA.

15. The method of claim 14, further comprising:
transmitting a request to report spatial reuse information to the plurality of STAs in the BSS; and
receiving the second spatial reuse information based at least in part on the request to report spatial reuse information.

16. The method of claim 14, further comprising:
transmitting a spatial reuse definition to the plurality of STAs in the BSS.

17. The method of claim 14, wherein:
the second spatial reuse information comprises at least one of a color bitmap identifying a color parameter for the second AP or an identifier for the second AP.

18. The method of claim 14, wherein:
the second spatial reuse information comprises at least one of a color index corresponding to the color parameter for the second AP or a identifier index corresponding to the identifier for the second AP.

19. The method of claim 14, further comprising:
transmitting a report request comprising a spatial reuse report time to the STA.

20. The method of claim 14, further comprising:
creating the third spatial reuse information based at least in part on the second spatial reuse information and additional spatial reuse information provided by other STAs of the plurality of STAs in the BSS.

21. The method of claim 14, further comprising:
creating the third spatial reuse information by updating the first spatial reuse information based at least in part on the second spatial reuse information.

22. An apparatus for wireless communication, comprising:
a processor;
memory in electronic communication with the processor; and
instructions stored in the memory and operable, when executed by the processor, to cause the apparatus to:
receive, by a station (STA) associated with a first access point (AP), a transmission from a second AP;
determine that the second AP is a member of a spatial reuse group based at least in part on receiving the transmission; and
transmit, to the first AP, one or more parameters of the second AP, the one or more parameters comprising at least one of a color parameter for the second AP or an identifier for the second AP.

23. The apparatus of claim 22, wherein the instructions are further executable by the processor to cause the apparatus to:
receive, from the first AP, information indicative of one or more parameters of spatial reuse groups within a coverage area of the first AP.

24. The apparatus of claim 22, wherein the instructions are further executable by the processor to cause the apparatus to:
determine, based at least in part on the transmission, that the at least one of the color parameter or the identifier for the second AP is unknown to the first AP; and
transmit the one or more parameters of the second AP to the first AP based at least in part on the determining that the at least one of the color parameter or the identifier is unknown to the first AP.

25. The apparatus of claim 22, wherein the instructions are further executable by the processor to cause the apparatus to:
receive, from the first AP, a request to report one or more parameters of spatial reuse groups within a coverage area of the STA; and
transmit the one or more parameters of the second AP to the first AP based at least in part on the request.

26. The apparatus of claim 22, wherein the instructions are further executable by the processor to:
receive, from the first AP, a spatial reuse definition; and
determine that the second AP is a member of a spatial reuse group based at least in part on the spatial reuse definition.

27. The apparatus of claim 22, wherein the instructions are further executable by the processor to:
receive, from the first AP, a spatial reuse report request, the spatial reuse report request comprising at least one of a request identifier, a report response time, a spatial reuse definition, or a report configuration; and
transmit the one or more parameters of the spatial reuse group based at least in part on the reuse report request.

28. An apparatus for wireless communication, comprising:
a processor;
memory in electronic communication with the processor; and
instructions stored in the memory and operable, when executed by the processor, to cause the apparatus to:
transmit, by an access point (AP), first spatial reuse information to a plurality of stations (STAs) in a basic service set (BSS) comprising the AP, the first spatial reuse information comprising at least one a color or an identifier of a second AP in a spatial reuse group having a coverage area that overlaps a coverage area of the first AP;
receive, from a STA of the plurality of STAs in the BSS, second spatial reuse information that comprises at least one of a color or an identifier of a third AP in the spatial reuse group; and
generate third spatial reuse information based at least in part on the second spatial reuse information received from the STA.

29. The apparatus of claim 28, wherein the instructions are further executable by the processor to cause the apparatus to:
transmit a request to report spatial reuse information to the plurality of STAs in the BSS; and
receive the second spatial reuse information based at least in part on the request to report spatial reuse information.

30. The apparatus of claim 28, wherein the instructions are further executable by the processor to cause the apparatus to:
transmit a report request comprising a spatial reuse report time to the STA.
